(19) United States
(12) Patent Application Publication
(10) Pub. No.: US 2021/0315214 A1
(43) Pub. Date: Oct. 14, 2021

(54) PESTICIDE

(71) Applicants: INL - International Iberian Nanotechnology Laboratory, Braga (PT); Embrapa, Brazilia (BR)

(72) Inventors: Maria Fátima GROSSI DE SA, Brazilia (BR); Leonardo Lima PEPINO DE MACEDO, Brazilia (BR); Maria Christina Mattar SILVA, Brazilia (BR); Rayssa Almeida GARCIA, Brazilia (BR); Luciano DA SILVA PAULINO, Brazilia (BR); Ana VILA, Braga (PT)

(73) Assignees: INL - International Iberian Nanotechnology Laboratory, Braga (PT); Embrapa, Brazilia (BR)

(21) Appl. No.: 17/256,660

(22) PCT Filed: Jul. 3, 2018
(86) PCT No.: PCT/EP2018/067922

§ 371 Date: Dec. 29, 2020

(51) Int. Cl. A01N 63/60; A01N 25/14; A01N 25/30

(52) U.S. Cl. CPC A01N 63/60; C08B 37/003; A01N 25/30; A01N 25/14

(57) ABSTRACT

The present invention relates to a process for manufacturing chitosan nanoparticles. The chitosan nanoparticles have dsRNAst adhered onto the surface of the particles. The dsRNAst is selected to have the property to gene silencing of AgraChSII. The invention does also relate to the chitosan nanoparticle, its use in pest-control, as pesticide, and a concentrated suspension containing the chitosan nanoparticles.

### TECHNICAL BACKGROUND

The present invention relates to nanoformulation of RNA, particularly stabilized double-stranded RNA (dsRNAst), in polymeric nanocapsules/particles of chitosan, also containing a cationic or neutral surfactants. Especially, the invention relates to a process for manufacturing chitosan nanoparticles including the RNA.

### BACKGROUND

Cotton is currently the world's most consumed fiber, mainly used in textile manufacturing, making its cultivation one of the most important commodities in world's economy. Brazil remains among the five major cotton producers in the world, along with China, India, the USA and Pakistan. Despite the applied control strategies, cotton production is severely affected by a huge array of insect-pests. Cotton cultivation most damaging insects are the lepidopterans fall armyworm (Spodoptera frugiperda) and the cotton bollworm (Helicoverpa armigera), and the coleopteran cotton boll weevil (Anthonomus grandis). The cotton boll weevil was reported for the first time in Brazil in 1983, and it is currently the most damaging insect-pest in Brazilian cotton plantations.

There is a need to develop environmental friendly insecticides, including insecticides containing RNA. It has been shown that chitosan has suitable properties as nucleic acid carrier, providing protection against nucleases and compatibility for cell uptake.

In U.S. Pat. No. 8,841,272 B2 a nanoparticle useful as insecticide is described. The nanoparticle comprises a biopolymer matrix wherein the insect double stranded RNA is entrapped, and the biopolymer matrix is in form of nanoparticles.

Also in US 2010/0015232 A1 nanoparticles of chitosan comprising RNA, as well a method for preparing the nanoparticles are described. The RNA included in the nanoparticles is used to modulate the expression of a target mRNA.

US 2013/0137747 A1 does also describe nanoparticles of polymeric matrix, and herein double-stranded RNA (dsRNA), which is gene silencing of an insect gene are included in the particles. A method for preparing the nanoparticles includes steps like, preparing a polymer matrix solution, a RNA solution, mixing the two solutions, and heating the solution before vortexing. Nanoparticles are said to be formed by self-assembling via electrostatic interaction between the dsRNA and the polymer matrix.

However, even if nanoparticles of chitosan including RNA, for example dsRNA, and methods for preparing the nanoparticles are known, there is a need for improvement, especially regarding stability of the particles, efficiency of the composition as pesticide, and the yield of the methods for manufacturing used.

In the present invention, the improvement of a specific but not restrict insecticide effect on the cotton boll weevil. This effect is mostly the enhancement and accuracy of gene silencing by producing and applying specific molecules of stabilized double-stranded RNA (dsRNAst), complexed to chitosan particles. The data also show that the gene silencing resulting from the use of the invention is caused not only by orally administered particles but also by topic delivery via spray. The effect is attributed to the inhibition of transcript levels of previously validated chitin synthase 2 (AgraCHS2) (Macedo et al., 2017), used here as an example.

### SUMMARY OF THE INVENTION

The present invention relates to a process for manufacturing chitosan nanoparticles, which upon RNA is adhered. The process for manufacturing provided provides more stable product, and produces nanopartices with a higher yield. With the nanoparticles with adhered RNA, for example the dsRNAst, provides an efficient method to assist insect-pest control, leading to the plant resistance to insect attack, due to the suppression of target gene(s) expression. The RNA, such as dsRNAst, administered via the nanoparticles is able to penetrate the insect integument, and is also delivered orally when the insect feeds on the sprayed plant, leading to the suppression of the expression of the target gene. The polymer forming the nanoparticle, such as chitosan, may also have the capability to enhance dsRNAst protection against degradation by gut nucleases. They also contribute to the internalization of dsRNAst molecules by insect cells.

An aspect of the invention is wherein the process comprises the following main steps:

A) formation of chitosan microparticles;
B) formation of chitosan nanoparticles from microparticles;
C) RNA coating on chitosan nanoparticles, and
D) retrieving the chitosan nanoparticles with RNA adsorbed on the surface.

Another aspect, the process is described more specifically, step A) the formation of chitosan microparticles includes the following steps:

i) providing an aqueous solution of chitosan, having a concentration of chitosan of 0.01-5%;

ii) adjusting pH in the solution to 5-6;

iii) adding cross-linking agent to a ratio crosslinking agent:chitosan of 1:1 to 1:4, preferably 1:2 in the solution, whereby chitosan microparticles are formed by ionic gelation;

iv) providing an aqueous suspension of the chitosan microparticles formed by precipitation;

B) formation of chitosan nanoparticles from microparticles;

i) forming chitosan nanoparticles, from the chitosan microparticles formed by the ionotropic gelation;

C) RNA coating on chitosan nanoparticles by

i) adding RNA to the aqueous solution of the chitosan nanoparticles,

ii) adding RNA to a ratio of RNA:chitosan of 1:80 in the solution;

wherein chitosan nanoparticles having adhered RNA are formed; and

iii) adding cationic or neutral surfactant to the chitosan nanoparticles.

An aspect of the invention is wherein the aqueous solution of chitosan comprises 0.01-5% by weight of chitosan, for example between 0.01-3%.

An aspect of the invention is when pH of the suspension is adjusted to pH of between 5 and 6.

RNA is to be absorbed on the nanoparticles. The RNA selected to be absorbed on the nanoparticle is aimed at gene silencing of AgraChSII.

The RNA can be linear stranded RNA or double stranded RNA (dsRNAst), and is preferably double stranded RNA (dsRNAst), as dsRNAst is more stable and has greater potential for silencing, especially silencing of AgraChSII. Other dsRNAst sequences are those which can be constructed as described in the patent

During the process, the concentration of chitosan in the aqueous solution is 0.01-5% (weight/weight), for example, the concentration of chitosan is 0.1-0.3 (weight/weight).

An aspect of the invention, the cross-linking agent is selected from the group of salts of monophosphate, diphosphate, polyphosphates. Examples of polyphosphate is triphosphate.

The microparticles of chitosan formed by ionic gelation are then treated to form nanoparticles. There are different methods available for forming the nanoparticles, for example, sonication, homogenisation, high pressure homogenisation, and ultra-pressure process.

An aspect of the invention is wherein the RNA is double stranded RNA (dsRNAst) aimed at gene silencing of AgraChSII.

An aspect of the invention is wherein the weight ratio of dsRNA to nanoparticles is from 1:0.001 to 1:1000.

Another aspect of the invention is that a cationic or neutral surfactant is added during the process, more specifically when RNA has been added to the chitosan nanoparticles.

Another aspect of the invention is chitosan nanoparticles having adhered RNA obtainable by the process described above.

In a further aspect, the invention is the nanoparticle herein defined, for use in pest-control.

By the present invention it is possible to reduce production costs, contributing to the reduction of pesticides used in the environment and to favor the increase of the cotton production.

The invention described here has great field-level application potential, being able to carry dsRNAst, which is more efficient than linear dsRNA at causing gene silencing in insect pests.

### BRIEF DESCRIPTION OF THE DRAWINGS

FIG. 1—Methodology scheme of three different methods for the chitosan:dsRNAst nanoparticle production. In all three methods, a nanoparticle dsuspension is obtained and the cationic surfactant is added at the final step, as escribed at examples 1, 2 and 3, respectively.

FIG. 2—Comparison between nanoparticle production characteristics obtained by the three methods described in this patent. A—Nanoparticle size obtained by dynamic light scattering (DLS) analysis; B—Conversion efficiency from chitosan to nanoparticles; C—dsRNAst encapsulation efficiency; D—AgraChSII gene silencing analysis by real time PCR. The experiment was performed in three biological and technical replicates. AgraActin and AgraTubulin were used as reference genes.

FIG. 3—Degradation analysis of dsRNAst associated to chitosan nanoparticles containing cationic surfactant by nucleases present in gut juice from CBW. A-Digestion assay performed with nanoparticles obtained by Method I; B—Digestion assay performed with nanoparticles obtained by Method III. Chitosan:dsRNAst proportion (mass/mass) used were: 0.05; 0.1; 0.2; 0.4; 0.8; 1.6; 3.2; 6.4; 12.8. 300 ng of dsRNAst was used for the nanoparticle synthesis. MM: molecular marker, GJ: gut juice, CH: chitosan, dsRNAst: dsRNAst-AgraChSII.

FIG. 4—AgraChSII gene silencing mediated by nanoparticles applied topically in cotton boll weevil (CBW) adult insects. The experiment was performed in three biological and technical replicates. AgraActin and AgraTubulin were used as reference genes.

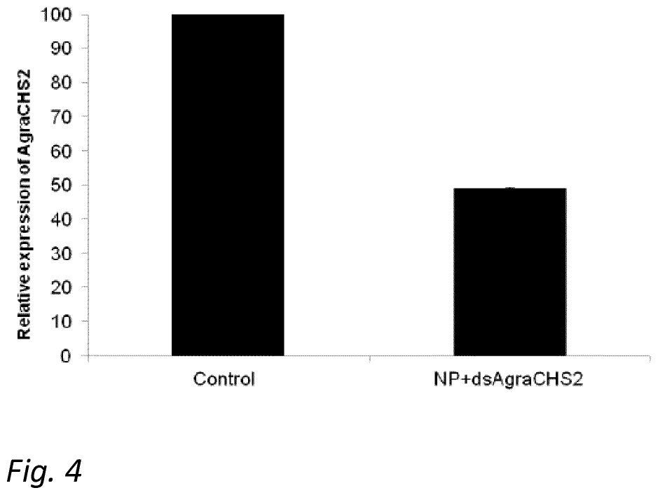

FIG. 5—Spreadability analysis of the nanoparticles containing cationic surfactant on cotton leaves surface. In this experiment the chitosan polymer was marked with Fluorescein-IsoThioCyanate (FITC). A and B—treatment with nanoparticle suspension not marked with FITC; C and D—treatment with nanoparticle suspension marked with FITC without cationic surfactant; E and F-treatment with nanoparticle suspension marked with FITC with cationic surfactant.

### DEFINITIONS

By the term ‘RNA’ it is herein meant to include both the double stranded RNA (dsRNA), as well as small interfering RNA (siRNA).

By the term ‘cross-linking agent’ it is herein meant a component having the capability to interact electrostatically with chitosan chains.

By the terms ‘monophosphate’, ‘diphosphate’, ‘polyphosphate’ it is meant are salts or esters of polymeric oxyanions formed from tetrahedral PO₄ (phosphate) structural units linked together by sharing oxygen atoms. The salts are formed with sodium, potassium, magnesium, or calcium. However, the list of counterions are not exhaustive.

By the term ‘TPP’ it is herein meant, sodium tripolyphosphate a cross-linking agent that interacts electrostatically with the polymer chain.

### DETAILED DESCRIPTION

The present invention relates to a process for manufacturing chitosan nanoparticles upon RNA is adhered.

The step A) the formation of chitosan microparticles includes the following steps:

i) providing an aqueous solution of chitosan, having a concentration of chitosan of 0.01-5%;

ii) adjusting pH in the solution to 5-6;

iii) adding cross-linking agent to a ratio crosslinking agent:chitosan of 1:1 to 1:4, preferably 1:2 in the solution, whereby chitosan microparticles are formed; by ionic gelation;

iv) providing an aqueous suspension of the chitosan microparticles formed by precipitation;

B) formation of chitosan nanoparticles from microparticles;

i) forming chitosan nanoparticles, from the chitosan microparticles formed by the ionic gelation,

C) RNA coating on chitosan nanoparticles by

i) adding RNA to the aqueous solution of the chitosan nanoparticles,

ii) adding RNA to a ratio of RNA:chitosan of 1:80 in the solution;

wherein chitosan nanoparticles having adhered RNA are formed; and

iii) adding cationic surfactant to the chitosan nanoparticles.

An aspect of the invention is wherein the aqueous solution of chitosan comprises 0.01-5% by weight of chitosan. The concentration within this range depends on the molecular weight of the polymer. Lower molecular weight (50-190 KDa) allows higher concentration of chitosan, for example between 0.1-10%. When the molecular weight of chitosan is high the concentration is selected between 0.2-0.4%, for example 0.2, 0.3 or 0.4%. The upper limit is given by the viscosity of the suspension.

The pH of the suspension is adjusted to pH of between 5 and 6. The adjustment can be done with addition of a commonly used acid or base. However, when the source of chitosan is a salt of chitosan, for example chitosan chlorhydrate, the pH ends up within the preferred pH interval, and there is no need to further adjust the pH. There is an advantage to provide a suspension of pH 5 and 6 when the process is performed in larger scales. The amount of crosslinking agent depends on the pH of the aqueous solution, lower pH, then a larger amount of crosslinking agent is required for preparing the particles; higher pH, then a lower amount of crosslinking agent is required for precipitation of chitosan

RNA is to be absorbed on the nanoparticles. The RNA selected to be absorbed on the nanoparticle is aimed at gene silencing of AgraChSII.

The RNA can be linear stranded RNA or double stranded RNA (dsRNAst), and is preferably double stranded RNA (dsRNAst), as dsRNAst is more stable and has greater potential for silencing, especially silencing of AgraChSII.

Preferably, the dsRNAst has a sequence specified in the Examples. The dsRNAst sequences were designed based on viroid genome architecture, which is composed of RNA without protein coat. Viroids are highly stable to plant nucleic acid degradation (Ding, 2009). The designed dsRNAst were evaluated and showed a 10-fold increase in gene silencing efficiency both in insect-pests and nematodes

During the process step A, i), the concentration of chitosan in the aqueous solution is 0.01-5% by weight, for example, the concentration of chitosan is 0.1-0.3% by weight.

Another parameter to consider during the process is the ratio of RNA to the chitosan. In step A, the ratio of RNA:chitosan shall be between 1:10:80 to 1:10:160. In step B, the concentration shall be up to 10 microgram of RNA, for example dsRNAst to 1 mg of nanoparticle in suspension. In a similar way, in step C) ratio of dsRNAst:chitosan shall be between 1:0.1 to 1:12.5, preferably 1:1.

The chitosan particles are formed together with a cross-linking agent. Herein, the cross-linking agent is selected from the group of monophosphate, diphosphate, polyphosphates. Examples of polyphosphate is triphosphate (TPP). During the formation of microparticles, the triphosphate is present in a concentration of at least 10 mg/ml, preferably 10 mg/ml. Another cross-linking agent, is substances from the group of sulfates, for example sodium sulfate.

During the process the crosslinking agent shall be present in an amount suitable related to the amount chitosan present in the suspension. In general, the ratio of chitosan:TPP shall be from 2:1 to 16:1. Example of ratio of crosslinking agent and chitosan.

The ratio of chitosan:crosslinking agent has an effect on the size of the formed particles, for example, ratio of 16:1, chitosan particles of 100-200 nm can be obtained, but in a low yield. With a ratio of 2:1, chitosan particles of 2-30 micrometer can be obtained, in a high yield. With the process herein described it is possible to obtain microparticles of 2-10 micrometer.

The microparticles of chitosan are formed by ionic gelation.

In one embodiment the process to form chitosan nanoparticles is by sonication, homogenisation, high pressure homogenisation, and ultra-pressure process. The size of the nanoparticles is less than 1 micrometer, for example less than 0.5 micrometer, such as between 100-400 nm.

An aspect of the invention is wherein the RNA is double stranded RNA (dsRNAst) aimed at gene silencing of AgraChSII. The dsRNAst is further defined in the Examples herein.

An aspect of the invention is wherein the weight ratio of dsRNA to nanoparticles is from 1:0.001 to 1:1000. Preferable a ratio of between 1:0.1 to 1:10.

A surfactant is added in during one of the steps in the process herein described, more specifically when the RNA has been added to the chitosan nanoparticles prepared. A surfactant present during the process provides a stabilizing effect on chitosan nanoparticle having the RNA absorbed thereon. The surfactant shall be cationic or neutral, and an example of suitable cationic or neutral, present in a concentration of 0.01% to 0.5% (weight/weight), for example in a concentration of 0.05% (weight/weight), as a final concentration to the suspension obtained during the process.

A further advantage of surfactant present in the nanoparticles is that they, upon use, can be uniformly dispersed on the surface where applied.

Another embodiment of the invention is chitosan nanoparticles having adhered RNA obtainable by the process described above.

In a further embodiment, the invention is the nanoparticle herein defined, for use in pest-control. Also a concentrated suspension of the chitosan nanoparticles is provided by the present invention.

In US 2016/0000086 A1 it is described the RNAi technology application to assist the control of the cotton boll weevil (CBW), Anthonomus grandis. For the validation of the invention, it was used a dsRNA containing the chitin synthase II sequence from CBW. It has been clarified that for the RNAi technology application aiming the effective control of crop insect pests, highly specific nucleotide sequences are chosen in non-conserved regions of the gene. This specific sequence is not observed in multiple alignments of different sequences of insect species that cohabit the same environment. That is, in other words, gene sequences used to produce dsRNA for CBW are different from the sequences of other insects. In this invention, the method developed to increase the gene suppression efficacy is highlighted. The chitin synthase II sequence from A. grandis (AgraChSII) was used for the exemplification and comparison of the increased effect caused by the nanoparticle application. Comparison has been made between the present invention and the technologies described in US 2016/0000086 A1.

In addition, the present invention regarding the nanoparticle includes the validation by bioassays (oral and topical administration) and analysis of the gene expression profile by real-time PCR. The applied methodology showed that the nanoparticle protects the dsRNA from nucleases degradation and improves its internalization by the insect's gut cells. Therefore, the present invention shows a advantage to potentialize the gene silencing efficacy (RNAi), since it shows an increase of the gene suppression effect when compared to the effect presented in the invention applying the non-protected dsRNA, by oral and topical administration. In the present invention, the main innovations that make this a singular patent, even if it is made with chitosan, is the use of RNA structured molecules (dsRNAst) and the addition of a cationic and/or neutral surfactant as a support to increase the nanoparticles spreadability on the leaf surface, as well as help the dsRNA penetration in the insect cuticle. Concluding, the nanoparticles provided by the present invention increases the gene silencing effect (RNAi) in crop insect pests. The use of dsRNAst adhered to nanoparticles, which is refractory to nucleases degradation and able to increase the gene silencing effect by 10 times. Also, the claimed process for manufacturing the nanoparticles is highly efficient, both in respect of conversion rate of the biopolymer in nanoparticle, and in the dsRNAst encapsulation rate. Further, the addition of cationic and/or neutral surfactants during the process, and which maintains in the formulation presents high compatibility with the biopolymer, allowing the nanoparticles to spread on the leaf surface and in its action as pesticide.

### EXAMPLES

It is to be understood that these examples are provided by way of illustration and nothing therein should be taken as a limitation upon the overall scope of the invention.
DNA Sequence (SEQ ID NO:1) Used for the dsRNAst from CBW Chitin Synthase II (AgraChSII) Synthesis and Used for Gene Silencing Bioassays:

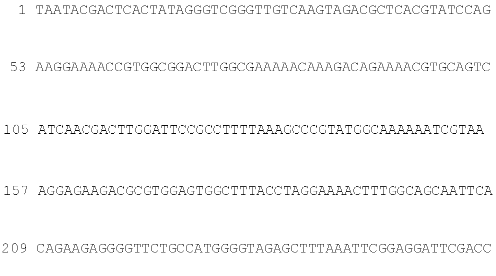

261 TTAAATCGTTCCTCCAAGAGCTCTTCCCCCAATCCCTTACTTGCGTAAGTAC

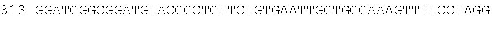

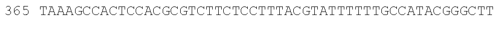

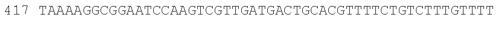

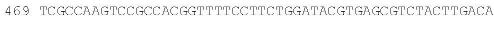

521 ACCCGAGACCAGACTACCGTGACAAGCCACTACGTGCGGCCCCATAGGACAG
573 TAGCAAGGGCCCGACGGTGAGTTCGTCGACACCTCTGCCCCTCCCAGGTACT
625 ATCCTCTTTCAAGGATGTGTTCCCTAGGAGGGTGAGTGTACCTCTTTTCGGA
677 TTTCTCCGGTCTTCCGAGAGAGACAGAGGACGGCCTCTCCCCATAGGGCCCA
729 AAGTCACGGTAGTCTGGTC

Sequence 1 to 30—T7 Promoter Sequence
Sequence 31 to 215—AgraChSII gene sense sequence
Sequence 216 to 331—Incompatibility ring 1
Sequence 332 to 516—AgraChSII gene anti-sense
Sequence 517 to 747—Incompatibility ring 2

### Example 1—Draw and Synthesis of the Structured dsRNA Aiming the Gene Silencing of AgraChSII

The drawing of the structured dsRNA with viroid architecture was validated by the RNAfold web server (http://rna.tbi.univie.ac.at/cgi-bin/RNAfold.cgi). The construction with the transcribed dsRNAst sequence was obtained by chemical synthesis and acquired from specialized company. In this construction, the region to be transcribed was flanked by the T7 promoter. The constructions contain the specific sequence of the chitin synthase II gene from CBW.

The dsRNAst was synthesized from PCR products flaked by the T7 promoter, and the PCR products were cloned and sequenced. 1.0 μg of PCR product was used as template for a 20 μL transcription reaction, as described by the manufacturer's protocol from the MEGAscript® T7 High Yield kit (Ambion). The reaction was incubated for 16 hours at 37° C., followed by a treatment with DNase I for 15 minutes. For dsRNAst alignment, the reaction product was incubated at 70° C. for 5 minutes and cooled at room temperature (22° C.). The transcription product was purified by phenol/chloroform and precipitated with isopropanol, as described by the manufacturer's protocol. The dsRNAst was resuspended in DEPC treated water and then quantified by spectrophotometry. The sense sequence and the respective antisense sequence of the target gene can be exchanged in place of the AgraChSII gene sequence.

### Example 2—Chitosan and dsRNAst Nanoparticle Synthesis Method I Aiming the AgraChSII Gene Silencing

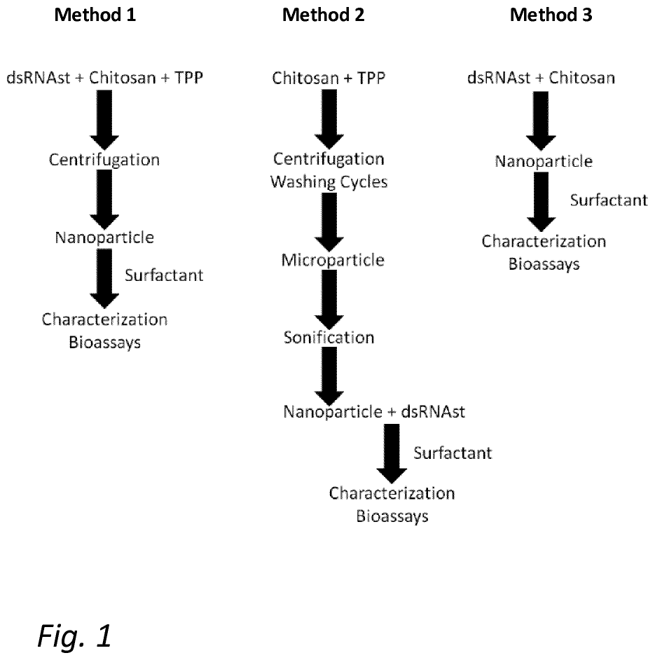

Chitosan (95% deacetylated) was dissolved in acetic acid 0.1 M, generating a chitosan solution 0.2% (2 mg/mL) and filtered in syringe filter 25 mm×0.22 μg (FilterPro). Around 25 μg of dsRNAst was added to 25 μL of sodium tripoliphosphate solution (TPP) (10 mg/mL) and homogenized. This solution was added in 10 μL aliquots to a 1 mL chitosan solution (2 mg/mL). The surfactant isopropilamine was added at a final concentration of 0.05%. The particles were centrifuged and analyzed by dynamic light scattering (DLS). A schematic model of the whole methodological procedure of the nanoparticles synthesis can be seen in FIG. 1. These particles were also used for bioassays in order to validate gene silencing phenotypic effects. In bioassays, the insects were fed with the nanoparticle containing the dsRNAst against the target gene AgraChSII.

### Example 3—Chitosan and dsRNAst Nanoparticle Synthesis Method II Aiming the AgraChSII Gene Silencing

In the Method II, chitosan microparticles were initially generated. For that, chitosan (95% deacetylated) was dissolved in acetic acid 0.1 M, generating a chitosan solution 0.2% (2 mg/mL). The solution pH was adjusted for 5.5 and the solution was filtered in syringe filter 25 mm×0.22 μg (FilterPro). With the objective of producing microparticles, it was added 2 mL of TPP solution (10 mg/mL) in a speed of 1 mL per minute to a 20 mL chitosan solution (2 mg/mL). After this period, the solution was kept in rest for 5 minutes at room temperature and centrifuged for 10 minutes at 5000×g. It was added 2 mL of TPP to the supernatant, and the precipitate was resuspended in 20 mL of distilled water and centrifuged for 10 minutes at 5000×g. The washing step was repeated three times, at least. Alternatively, in order to form microparticles, 1M NaSO4 solution was added up to 0.1M, and washing steps were followed. The precipitate was finally resuspended in water and sonicated for 5 minutes with amplitude of 30% in an ice bath. 20 μg of dsRNAst was added to the nanoparticle suspension and the surfactant isopropolamine was added at the final concentration of 0.05%. The particles were centrifuged and analyzed by DLS. These particles were also used in bioassays in order to validate phenotypic effects on the gene silencing through oral delivery (FIG. 1).

### Example 4—Chitosan and dsRNAst Nanoparticle Synthesis Method III Aiming the AgraChSII Gene Silencing

Chitosan (95% deacetylated) was dissolved in acetic acid 0.1 M, generating a chitosan solution of 0.2% (2 mg/mL). The pH solution was adjusted to 5.5, and the solution was filtered in syringe filter 25 mm×0.22 μg (FilterPro). The dsRNAst was added in a constant concentration of 300 ng. The chitosan/dsRNAst ratios (mass/mass) was: 0.05, 0.1, 0.2, 0.4, 0.8, 1.6, 3.2, 6.4 and 12.8 in a reaction volume of 20 μL in triple buffer pH 5.5 (Schaffer et al, 2004). The surfactant isopropolamine was added at the final concentration of 0.05% (FIG. 1). These nanoparticles were used for bioassays to validate gene silencing phenotypic effects. In bioassays, the insects were fed with the nanoparticle containing the dsRNAst against the target gene AgraChSII.

### Example 5—Comparison of the Nanoparticles Production Characteristics and dsRNAst Encapsulation Efficiency of the Three Methods Described

In order to assess the biopolymer conversion rate to nanoparticles obtained by the three different methods described in this patent, it was used chitosan marked with activated FITC fluorophore. 100 mg of chitosan (95% deacetylated) was dissolved in 50 mL of acetic acid 0.1 M, generating a chitosan 0.2% solution (2 mg/mL) and the pH solution was adjusted to 5.5. 1 mg of FITC was dissolved in methanol and added to the chitosan solution. The mixture was incubated in agitation for 2 hours. After this period, chitosan was precipitated with four volumes of acetone, centrifuged and washed two times with acetone 80%. The precipitated chitosan was freeze-dried and then resuspended in acetic acid 0.1 M, generating a 0.2% chitosan solution (2 mg/mL). Marked nanoparticles with FITC were prepared following methods I, II and III as described in this patent. The supernatant obtained after the nanoparticles generation was used to calculate the amount of chitosan still in solution, based on the chitosan-FITC standard curve, previously established.

To validate the dsRNAst encapsulation rate by the nanoparticles, 5 μg of dsRNAst was used as a reference quantity to be encapsulated by 1 mL of chitosan 0.2%. The dsRNAst present in the supernatant after nanoparticle synthesis was quantified by spectrophotometry in the Nanodrop™. The encapsulation rate was calculated based on the difference between initial and final concentrations obtained before and after encapsulation. The experiment was performed in triplicate, in three independent nanoparticle production lots, for each method.

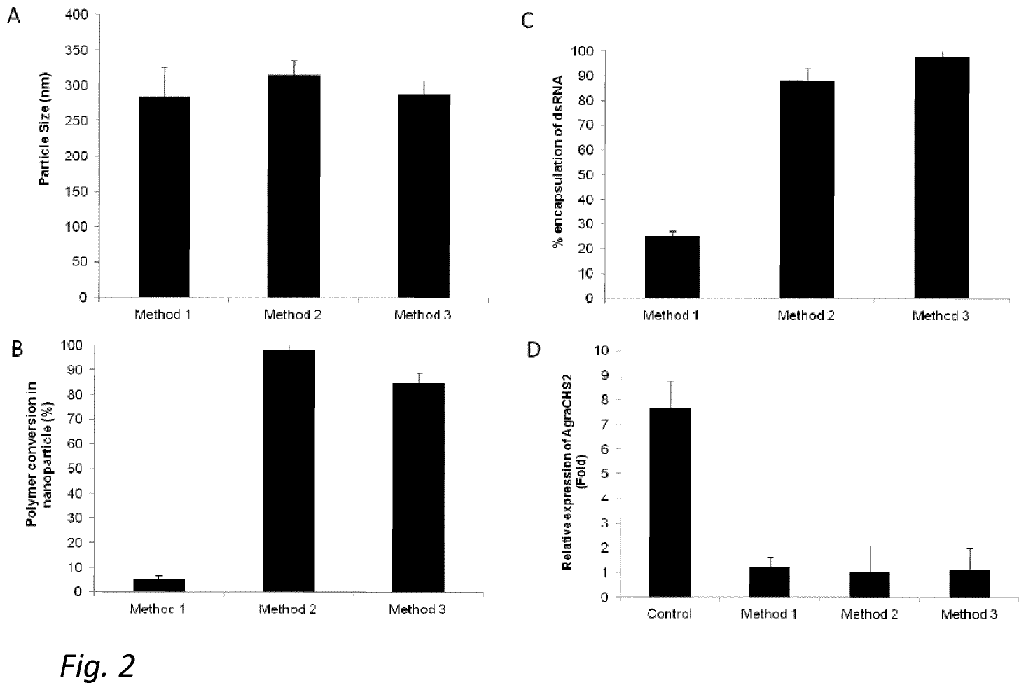

The three synthesis methods generated nanoparticles with different sizes, varying between 283 and 315 nanometers (FIG. 2A). It was not verified any significant difference on the nanoparticle sizes in the different methods. Yet, the chitosan conversion rate to nanoparticles was only 5% for Method I, 98.5% for Method II and 85% for Method III (FIG. 2B). In method III, the chitosan conversion rate to nanoparticles was obtained above 98% using chitosan/dsRNAst ratios (mass/mass) of 0.2. The dsRNAst encapsulation rate during the nanoparticle formation was just 25% for Method I, 88% for Method II and 98% for Method III (FIG. 2C).

### Example 6—Degradation Analysis of Chitosan Encapsulated dsRNAst by the Gut Juice from CBW

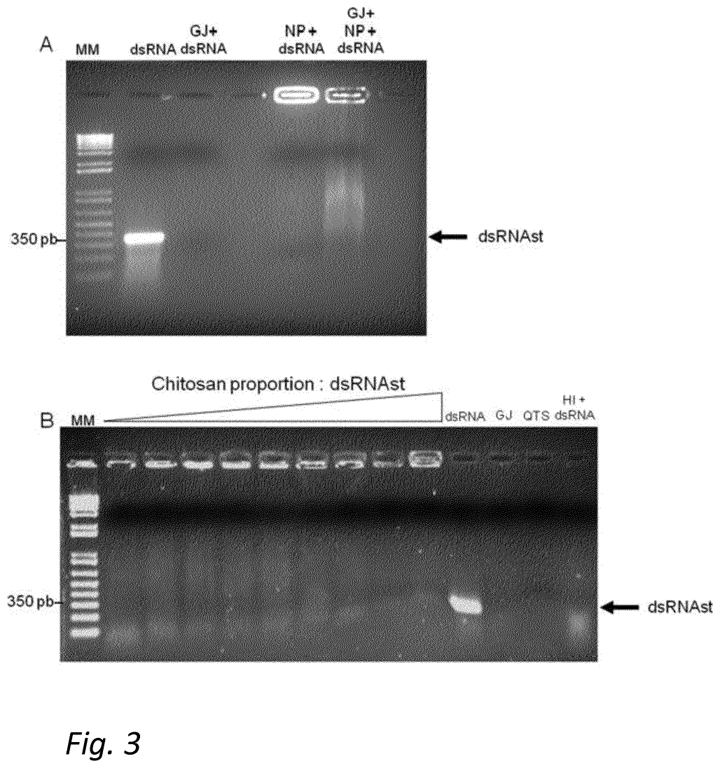

The chitosan:dsRNAst nanoparticle suspension formulated in different ratios of chitosan:dsRNAst (mass/mass) was incubated for 30 minutes with 1 μg of gut juice from CBW. The gut juice was collected following the protocol described by Gillet et al (2017) in a 20 μL solution in triple buffer pH 5.5. The integrity of the dsRNAst associated to the chitosan nanoparticle was analyzed on 1% agarose gel stained with ethidium bromide (FIG. 3). The nanoparticle suspensions obtained by the three different methods were able to protect the dsRNAst from CBW's gut nuclease degradation. It was observed that integrate nanocomplexes with chitosan and dsRNAst were retained at the gel wells. In assays performed with nanoparticles synthesized by Method II, described at Example 3, it was observed that when treated with CBW's gut juice, the dsRNAst from the nanocomplex was not degraded by gut nucleases and that the majority was retained in the gel well (FIG. 3A). Using the nanoparticles synthesized by Method III, even with small amounts of chitosan, the dsRNAst remains intact in the presence of gut nucleases (FIG. 3B). In high chitosan concentrations, there is no dsRNAst migration and it is retained in the gel well, both on control and on the presence of gut nucleases. Without chitosan, the dsRNAst is completely degraded. It can be concluded that in vitro, even in small quantities, chitosan promotes dsRNAst protection from CBW's gut nucleases.

### Example 7—Oral and Topical Administration of the Chitosan:dsRNAst Nanoparticle

7.1. Nanoparticle Administration Through Feeding

Adult insects were kept in starvation for 48 hours (n=10). Next, the nanoparticle containing 300 ng of dsRNAst (AgraChSII) and 500 ng of chitosan was diluted in sucrose 5% and orally administered to the insects (FIG. 7). As controls, samples containing dsRNAst-AgraChSII (300 ng) and chitosan (500 ng) were used. After 72 hours, insects were frozen in liquid nitrogen and stored at −80° C. for future analysis. The assay was performed in three biological replicates.

7.2. Nanoparticle Administration Through Topical Application

Adult insects were submitted to pulverization with a solution containing nanoparticles synthesized by the Method III (dsRNAst AgraChSII 300 ng/μL, chitosan 500 ng/μL). As a control, empty nanoparticles (chitosan 500 ng/μL) and dsRNA (300 ng/μL) were used. The application was realized by spraying and the insects were frozen in liquid nitrogen after 72 hours and stored at −80° C. for future analysis. The assay was performed in three biological replicates.

### Example 8—Analysis of the Gene Expression of AgraChSII by Real Time PCR

CBW samples previously stored at −80° C. were pulverized in liquid nitrogen and total RNA extraction was performed with TRIzol (Invitrogen), following manufacturer's protocol. cDNA synthesis was realized with 2.0 μg of RNA using the MMLV kit (Invitrogen) and the NvDt30 primer, following manufacturer's protocol. The real-time PCR was performed using SYBR Green (Promega) as intercalating fluorophore and primers for the genes AgraChSII, AgraActin and AgraTubulin, which were used as reference genes (Table 1). The reaction was set according to manufacturer's protocol and the program at the PCR machine (Applied 7300 Real Time PCR System—Applied Biosystems) consisted of 1 cycle of 10 minutes at 95° C., 40 cycles of 20 seconds at 95° C., 30 seconds at 55° C. and 30 seconds at 72° C. The analysis of the relative expression was realized at the qBasePlus 2.0 program by the method Pfaffl (Hellemans et al, 2007). The assay was performed in three biological (n=10) and technical replicates. Statistical analysis was performed by the Turkey method with 0.05% of significance for comparison between treatments.

In order to validate the potential of the nanoparticle suspension to cause gene silencing in CBW it was performed an experiment of nanoparticle oral delivery, as described in Example 7. After the transcript analysis by real time PCR, it was verified that the target gene was silenced by all three methods described in this patent. It was verified the silencing of 84%, 86% and 84% for the nanoparticles synthesized by the methods I, II and III, respectively (FIG. 2D).

The gene silencing through nanoparticle topical application experiment was performed spraying the nanoparticle solution on the adult insect. After 72 hours the insects were collected for analysis of the target gene, verifying a decrease of 48.9% on the expression of AgraChSII (FIG. 3).

### Example 9—Evaluation of the Wettability of Chitosan:dsRNAst Nanoparticle Suspension on Cotton Leaves

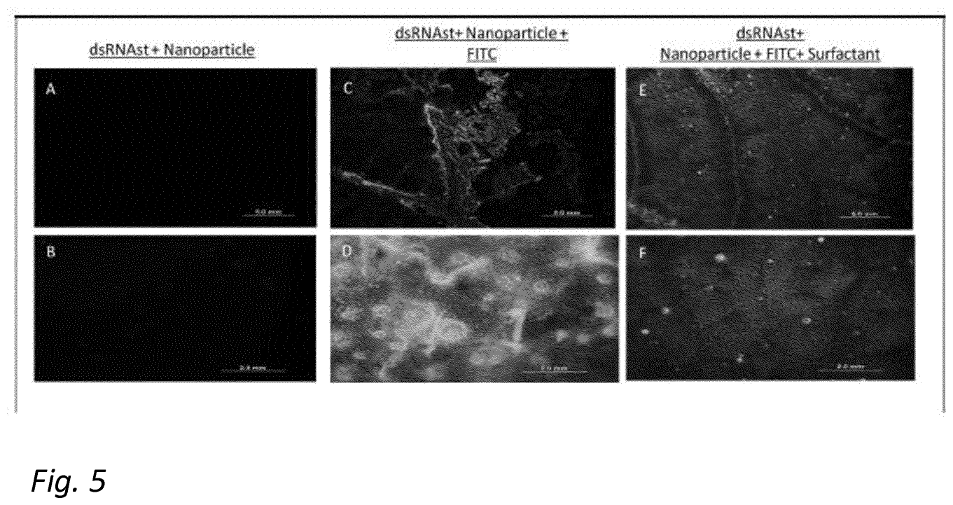

In order to verify the chitosan:dsRNAst nanoparticles wettability on cotton leaves, nanoparticles were marked with activated fluorophore FITC. 100 mg of chitosan (95% deacetylated) was dissolved in 50 mL of acetic acid 0.1 M, generating a 0.2% chitosan solution (2 mg/mL) and the solution pH was adjusted to 5.5. 1 mg of FITC was dissolved in methanol and added to the chitosan solution. The mixture was left in agitation for 2 hours. After this period, chitosan was precipitated with four volumes of acetone, centrifuged and washed two times with acetone 80%. Precipitated chitosan was freeze-dried and marked chitosan was resuspended in acetic acid 0.1 M, generating a 0.2% chitosan solution. FITC marked nanoparticles were prepared following the Method II protocol described in this patent. The nanoparticle suspension containing cationic surfactant and controls with no surfactant were applied with hand sprayer on cotton leaves. After one hour, leaves were excised and analyzed in fluorescence binocular stereomicroscope (FIG. 5).

It was verified that the nanoparticle suspension containing cationic surfactant was able to uniformly disperse above leaf surface. On the contrary, nanoparticles with no surfactant were aggregated at the leaf. Therefore, the use of cationic surfactant such as isopropilamine stabilizes the nanoparticle suspension and allows its spreadability above vegetable tissues.

While the invention has been described in connection with what is presently considered to be the most practical embodiments, it is to be understood that the invention is not to be limited to the disclosed embodiments, but on the contrary, it is intended to cover various modifications and equivalents included within the spirit and scope of the appended claims.

### REFERENCES

DING, B. The biology of viroid-host interactions. Annual Review of Phytopathology. Volume 47, 105-131, 2009.
GILLET, F X., GARCIA, R A., MACEDO, LLP., ALBUQUERQUE, EVS., SILVA, MCM, GROSSI-DE-SA, M F., Investigating engineered ribonucleoprotein particles to improve oral RNAi delivery in crop insect pests. Frontiers in Plant Physiology, v. 8, n. 256, p. 1-15, 2017.
HELLEMANS, J., MORTIER, G., DE PAEPE, A., SPELEMAN, F., VANDESOMPELE, J., QBASE relative quantification framework and software for management and automated analysis of real-time quantitative PCR data. Genome Biology, v. 8, n. 2, p. 1-14, 2007.
MACEDO, LLP, ANTONINO-DE-SOUZA JUNIOR, J D, COELHO, R R, FONSECA, FCA, FIRMINO, AAP, SILVA, MCM, FRAGOSO, R R, ALBUQUERQUE, EVS, SILVA, M S, DE ALMEIDA ENGLER, J, TERRA, W R, GROSSI-DE-SA, M F. Knocking down chitin synthase 2 by RNAi is lethal to the cotton boll weevil. Biotechnology Research and Innovation, p. 1-15. 2017.
SCHAFER P., SCHOLZ, S R, GIMADUTDINOW, O, CYMERMAN, I A, BUJNICKI, J M, RUIZ-CARRILLO, A, PINGOUD, A, MEISS, G, Structural and functional characterization of mitochondrial EndoG, a sugar non-specific nuclease which plays an important role during apoptosis. Journal of Molecular Biology, v. 338, p. 217-228, 2004.

1. A process for manufacturing chitosan nanoparticles having adhered RNA, the process comprising the following steps:
A) formation of chitosan microparticles;
i) providing an aqueous solution of chitosan, wherein the concentration of chitosan is 0.01-5%;
ii) adjusting pH of the solution to 5-6;
iii) adding cross-linking agent to a ratio crosslinking agent:chitosan of 1:1 to 1:4, preferably 1:2 in the solution, whereby chitosan microparticles are formed; preferably by ionic gelation,
iv) providing an aqueous suspension of the chitosan microparticles formed by precipitation,
B) formation of chitosan nanoparticles from microparticles;
i) forming chitosan nanoparticles, from the chitosan microparticles formed by the ionic gelation;
C) RNA coating on chitosan nanoparticles
i) adding RNA to the aqueous solution of the chitosan nanoparticles,
ii) adding RNA to a ratio of RNA:chitosan of 1:80 in the solution;
wherein chitosan nanoparticles having adhered RNA are formed; and
iii) adding cationic surfactant to the chitosan nanoparticles.

2. The process according to claim 1, wherein the adhered RNA is stabilized double stranded RNA (dsRNAst), preferably a dsRNAst of SEQ ID NO 1.

3. The process according to claim 1, wherein the concentration of chitosan in the acidic aqueous solution is 0.01-5% (weight/weight), preferably 0.1-0.3% (weight/weight).

4. The process according to claim 1, wherein the cross-linking agent is selected from the group consisting of salts of monophosphate, diphosphate, polyphosphates.

5. The process according to claim 1, wherein the forming chitosan nanoparticles is by sonication, homogenisation, or high pressure homogenisation.

6. The process according to claim 1, wherein the dsRNAst is dsRNA aimed at gene silencing of AgraChSII.

7. The process according to claim 6, wherein the weight ratio of dsRNAst to nanoparticles is from 1:0.001 to 1:1000.

8. The process according to claim 1, wherein the cationic surfactant is selected from isopropylamine, and neutral surfactant is selected from polysorbate.

9. The process according to claim 1, wherein the cationic surfactant is present in a concentration of 0.01-0.2% (weight/weight); in a concentration of 0.05% (weight/weight).

10. Chitosan nanoparticles having adhered RNA obtainable by the process according to claim 1.

11. A nanoparticle according to claim 10 for use in pest-control.

12. A concentrated suspension comprising the chitosan nanoparticles as defined in claim 1.


SEQUENCE LISTING (1 sequence)

SEQ ID NO: 1 - DNA, 747 bp, Artificial Sequence
  Description of Artificial Sequence Synthetic polynucleotide
taatacgactcactatagggtcgggttgtcaagtagacgctcacgtatccagaaggaaaaccgtggcggacttggcgaaaaacaaagacagaaaacgtgcagtcatcaacgacttggattccgccttttaaagcccgtatggcaaaaaatacgtaaaggagaagacgcgtggagtggctttacctaggaaaactttggcagcaattcacagaagaggggttctgccatggggtagagctttaaattcggaggattcgaccttaaatcgttcctccaagagctcttcccccaatcccttacttgcgtaagtacggatcggcggatgtacccctcttctgtgaattgctgccaaagttttcctaggtaaagccactccacgcgtcttctcctttacgtattttttgccatacgggctttaaaaggcggaatccaagtcgttgatgactgcacgttttctgtctttgtttttcgccaagtccgccacggttttccttctggatacgtgagcgtctacttgacaacccgagaccagactaccgtgacaagccactacgtgcggccccataggacagtagcaagggcccgacggtgagttcgtcgacacctctgcccctcccaggtactatcctctttcaaggatgtgttccctaggagggtgagtgtacctcttttcggatttctccggtcttccgagagagacagaggacggcctctccccatagggcccaaagtcacggtagtctggtc